(19) United States
(12) Patent Application Publication
(10) Pub. No.: US 2007/0299679 A1
(43) Pub. Date: Dec. 27, 2007

(54) Business system interface

(75) Inventors: Amit Sudan, Hyderabad (IN); Manbhawan Prasad, Hyderabad (IN); Maninderjit Singh, Hyderabad-28 (IN); Rohit Bhatia, New Delhi (IN); Sandeep Sadanandan, Munich (DE)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/508,612

(22) Filed: Aug. 23, 2006

(30) Foreign Application Priority Data
Jun. 26, 2006 (IN) 1497/DEL/2006

(51) Int. Cl. G06Q 10/00; G06Q 30/00

(52) U.S. Cl. 705/1

(57) ABSTRACT

A business system interface for accessing data from a Line-of-Business (LOB) system from within an information worker productivity (IWP) application is provided. The business system interface includes an embedded business system user interface contained within a user interface of the IWP application. Also included, is a business data access component that can retrieve data from the LOB system and provide the retrieved data to the embedded business system user interface. The embedded business system user interface and the business data access component contain at least some managed code components.

The present application claims priority of International patent application in India filed Jun. 26, 2006 and bearing serial number 1497/DEL/2006, the content of which is hereby incorporated by reference in its entirety.

### BACKGROUND

Line-of-business (LOB) applications are vital technology for today's knowledge intensive businesses. LOB applications or systems can include a range or bundle of specialized systems including but not limited to accounting, enterprise resource planning (ERP), and customer relation management (CRM). LOB applications provide users with crucial information/data concerning the pulse of a business.

In most large businesses, there are a number of users who need to access business data but do not spend a substantial amount of their time using LOB applications or find them too difficult or non-intuitive to use. However, most of these users have access to, and are more comfortable with, Information Worker Productivity (IWP) applications such as word processing applications, spreadsheet applications, etc.

Thus, there is a need for a system/application that provides access to business data in a LOB system from within an IWP application.

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

The present embodiments relate to a business system interface for accessing data from a Line-of-Business (LOB) system from within an Information Worker Productivity (IWP) application. The business system interface includes an embedded business system user interface contained within a user interface of the IWP application. Also included, is a business data access component that can retrieve data from the LOB system and provide the retrieved data to the embedded business system user interface. The embedded business system user interface and the business data access component contain at least some managed code components.

### BRIEF DESCRIPTION OF THE DRAWINGS

FIG. 1 is a block diagram of one illustrative computing environment in which the present embodiments can be implemented.

FIG. 2 is a block diagram of an alternative computing environment in which the present invention may be practiced.

FIG. 3 is a simplified block diagram of a software system that includes a business system interface in accordance with one of the present embodiments.

FIGS. 4-1 and 4-2 are simplified block diagrams that illustrate business system interface architectures in accordance with the present embodiments.

FIGS. 5-1 through 5-9 are screen shots of an example IWP application user interface (or window) with an embedded business system user interface (or pane).

FIG. 6 is a flowchart of a method embodiment.

### DETAILED DESCRIPTION

The present embodiments deal with a business system interface for accessing data from a Line-of-Business (LOB) system from within an Information Worker Productivity (IWP) application. However, before describing the present embodiments in greater detail, illustrative environments in which the present embodiments can be used will be described.

### Exemplary Computing Environments

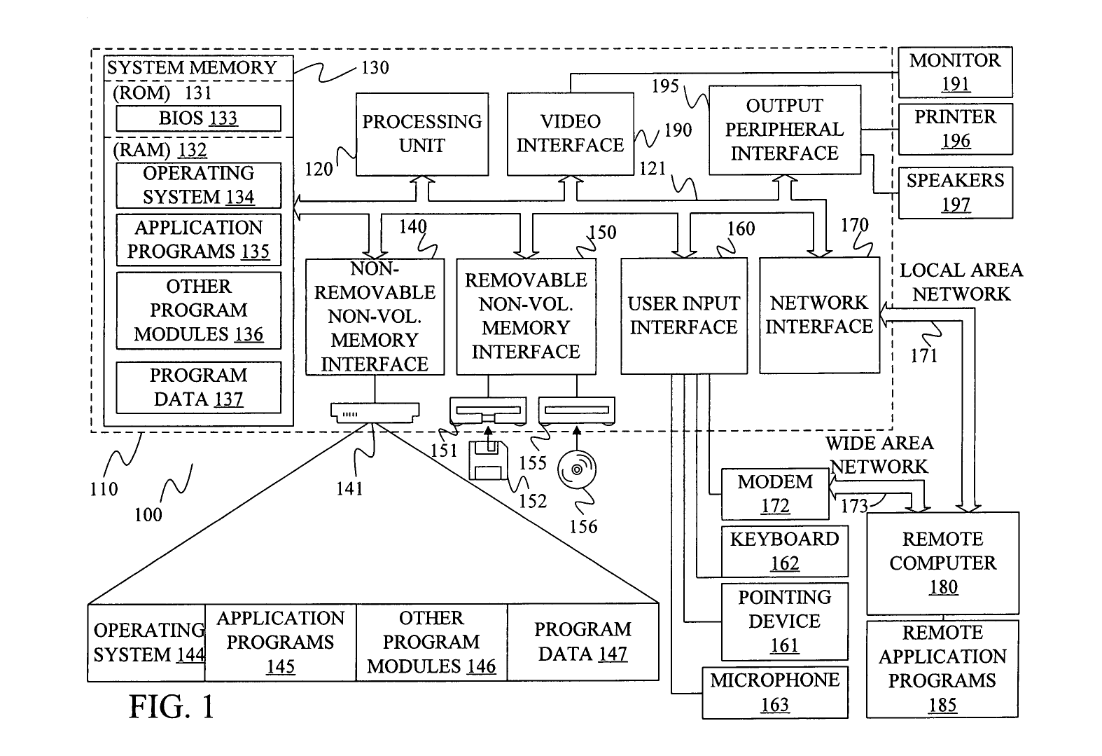

FIG. 1 illustrates an example of a suitable computing system environment 100 on which the present embodiments may be implemented. The same reference numerals are used in the various figures to represent the same or similar elements. The computing system environment 100 is only one example of a suitable computing environment and is not intended to suggest any limitation as to the scope of use or functionality of the present embodiments. Neither should the computing environment 100 be interpreted as having any dependency or requirement relating to any one or combination of components illustrated in the exemplary operating environment 100.

The present embodiments are operational with numerous other general purpose or special purpose computing system environments or configurations. Examples of well-known computing systems, environments, and/or configurations that may be suitable for use with the present embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The present embodiments may be described in the general context of computer-executable instructions, such as program modules, being executed by a computer. Generally, program modules include routines, programs, objects, components, data structures, etc. that perform particular tasks or implement particular abstract data types. The present embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the present embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

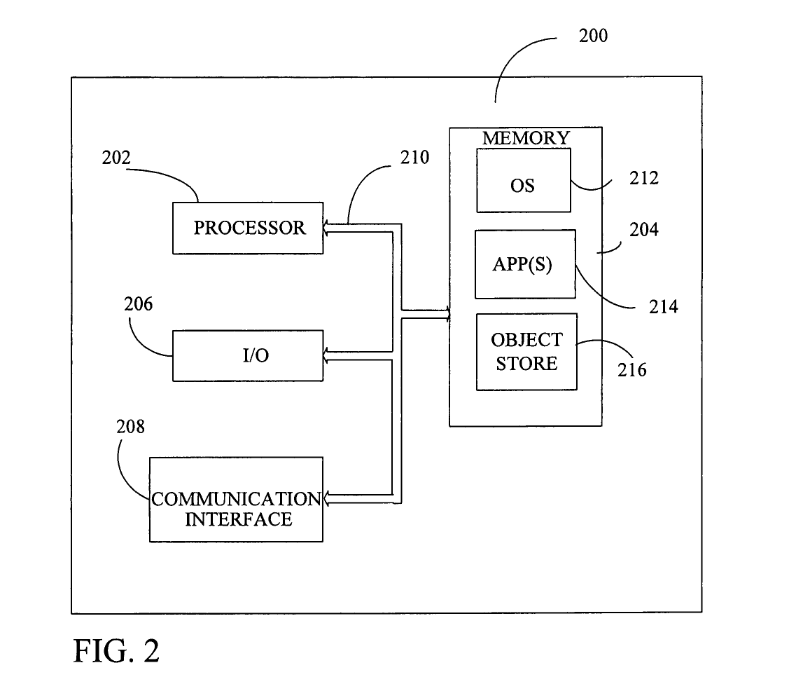

FIG. 2 is a block diagram of a mobile device 200, which is an exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200 within the scope of the present embodiments.

### General Business System Interface Embodiments

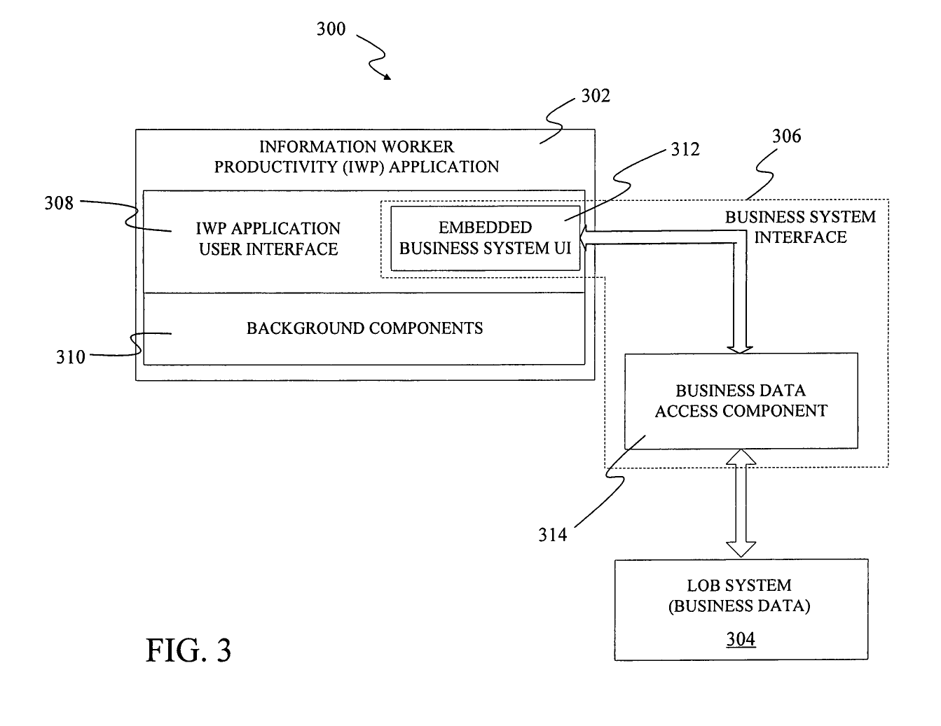

FIG. 3 is a simplified block diagram of a software system 300 that includes a business system interface 306 in accordance with one of the present embodiments. Software system 300 includes an IWP application 302 (an application that most computer users are comfortable with such as a word processing application, a spreadsheet application, a messaging and/or scheduling application, etc.), a LOB system 304 and business system interface 306.

Application 302 includes an IWP application user interface (screen(s) or window(s)) 308 and background components 310, which are transparent to a user but are integral to the functionality of the IWP application 302. LOB system 304 may be an accounting system, an enterprise resource planning (ERP) application, a customer relation management (CRM) application, etc. LOB system 304 contains business information/data. In accordance with the present embodiments, business system interface 306 provides a user with access to business data from LOB system 304 from within IWP application 302.

Business system interface 306 includes a user interface 312, which is embedded within IWP application user interface 308. For example, embedded business system user interface 312 can be a pane within a window of IWP application user interface 308. Also included within business system interface 306 is a business data access component 314 that, in response to receiving a user-initiated request from embedded user interface 312, can retrieve business data from the LOB system 304 and provide the retrieved business data to the user interface 312. As will be apparent from a description of the business system interface architecture provided further below, embedded business system user interface 312 and/or business data access component 314 can contain at least some managed code components.

In general, managed code is code that is developed with a language compiler that targets the runtime. Managed code benefits from features such as cross-language integration, cross-language exception handling, enhanced security, versioning and deployment support, a simplified model for component interaction, and debugging and profiling services. In contrast with managed code, which comprises intermediate assembly language code, unmanaged executable files are essentially binary images loaded into memory. In some of the present embodiments, the managed code components have their execution managed by a NET Framework Common Language Runtime.

As mentioned above, due to the inclusion of business system interface 306, a user of software system 300 can access business data from within IWP application 302, thereby eliminating a need for the user to switch applications in order to access business information/functionality. Example architectures of system 300 are first provided in connection with FIGS. 4-1 and 4-2. Thereafter, a description of detailed embodiments of business system interface is provided further below in connection with FIGS. 5-1 through 5-9.

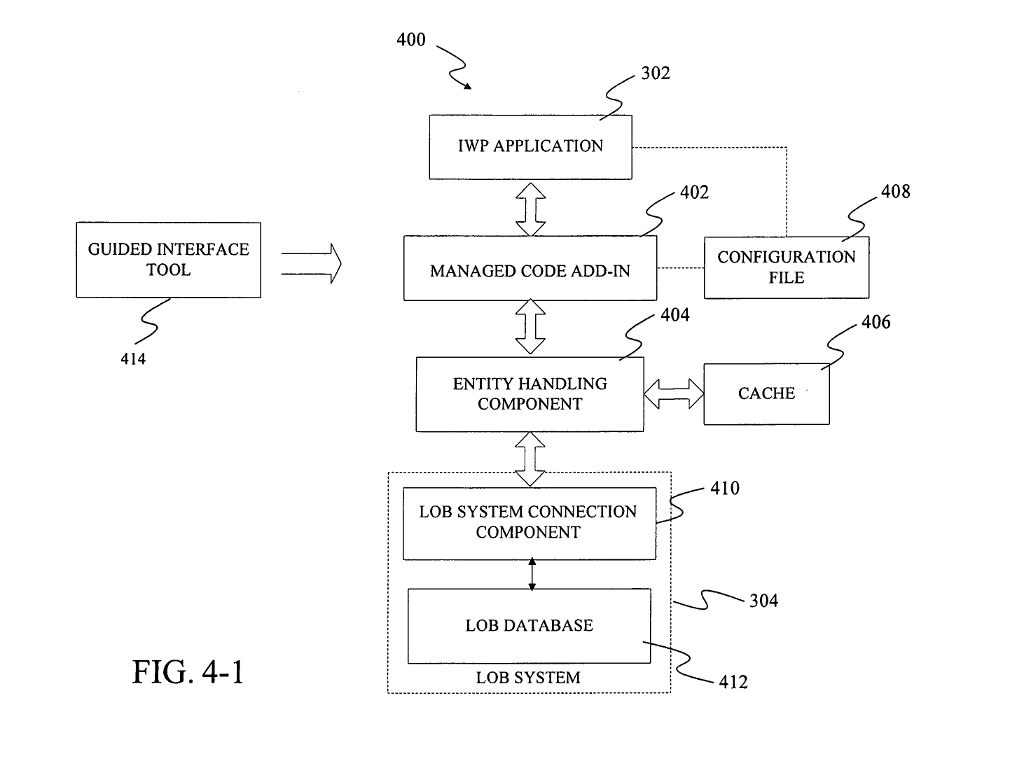

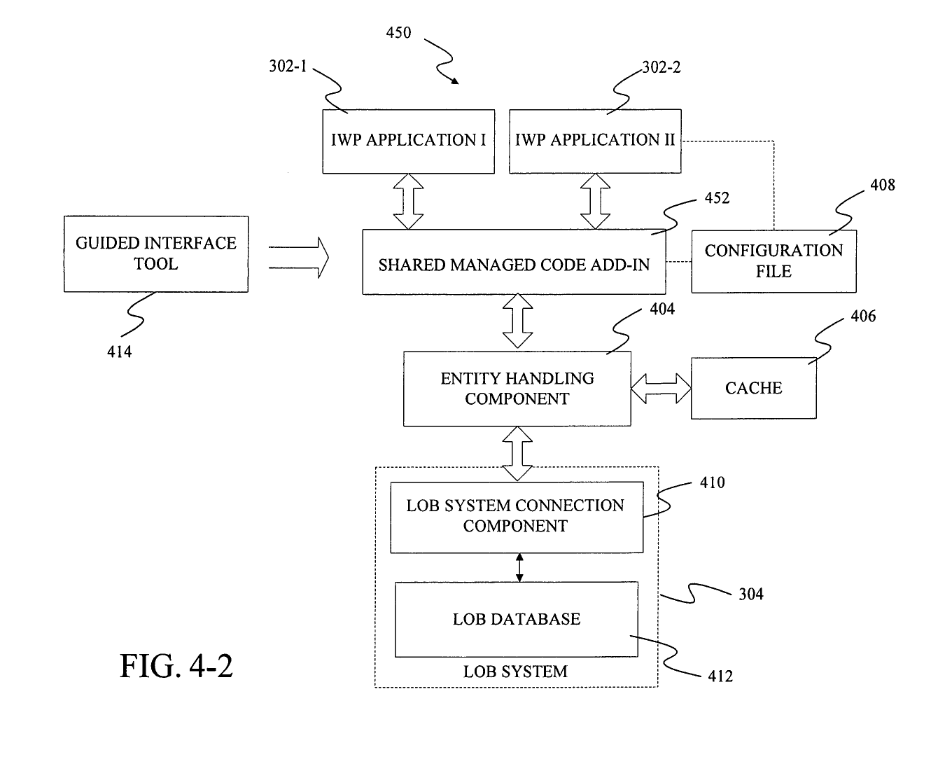

FIG. 4-1 is a simplified block diagram 400 that illustrates a business system interface architecture for accessing business data from a LOB system 304 from within an IWP application 302 in accordance with one of the present embodiments. In FIG. 4-1, managed code add-in 402, entity handling component 404, business data cache 406 and configuration file 408 constitute the business system interface.

Managed code add-in 402, together with configuration file 408 (an example of which is provided further below), define the embedded business system user interface by dictating which business data entities/attributes are available in the embedded business system user interface, its view and grid size limit, etc. Further, managed code add-in 402 helps carry out various functions (which are described in detail further below) that are available to a user of the embedded business system user interface.

Functions carried out by entity handling component 404 include retrieving entities form LOB system 304 and providing the retrieved entities to the embedded business system user interface. Cache 406 temporarily stores business data records and is periodically refreshed with the help of entity handling component 404. In some of the present embodiments, cache 406 is used by entity handling component 404 to carry out a “quick” lookup up of business data records that were previously searched.

LOB system connection component 410 can be any suitable component that can receive a generalized request (non-database specific request) for business data, convert the request into a form suitable for retrieving necessary records from LOB database 412, and return the retrieved data to the requesting component, which, in the present embodiments, is entity handling component 406. Example LOB system connection components include a known Component Object Model (COM) connector for an ERP application and a known Web Services Component for a CRM application.

As noted earlier, configuration file 408 defines which business data entities/attributes are available in the embedded business system user interface. Configuration file 408 can be viewed as a filter on top of business data that is returned from LOB system 304. An example Extensible Markup Language (XML) configuration file that can be used in conjunction with a managed code add-in (such as 402) is included below. An explanation of each tag in the example configuration file is provided in Table 1 that immediately follows the example configuration file.

### Example Configuration File

```
<?xml version=“1.0” encoding=“utf-8” ?>
<CrmOfficeConfig>
      <SysConfig>
<MetaDataRefreshTime>5</MetaDataRefreshTime>
          <MaxRecordCount>5</MaxRecordCount>
        <CacheEntryCount>5</CacheEntryCount>
    </SysConfig>
<Entities>
    <entity name=“account” IsExcluded=“no”>
            <related name=“contact” IsExcluded=“yes”
/>
    </entity>
    <entity name=“contact” IsExcluded=“yes”>
          <related name=“account” IsExcluded=“yes”
/>
          <attribute name=“name” IsExcluded=“yes” />
      </entity>
  </Entities>
</CrmOfficeConfig>
```

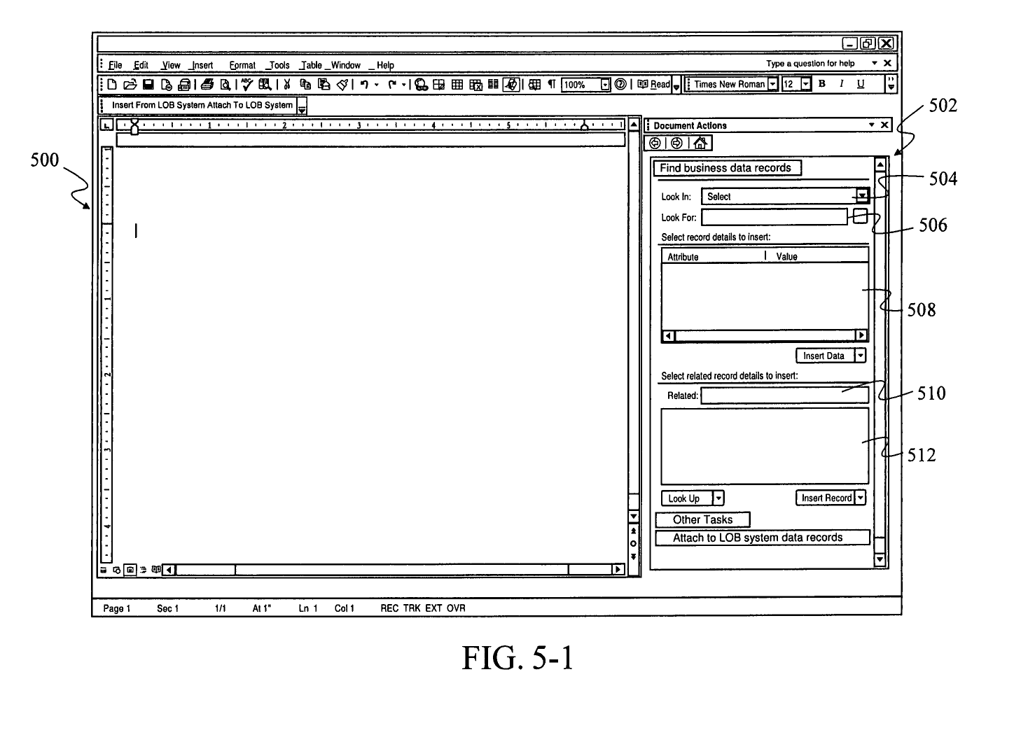

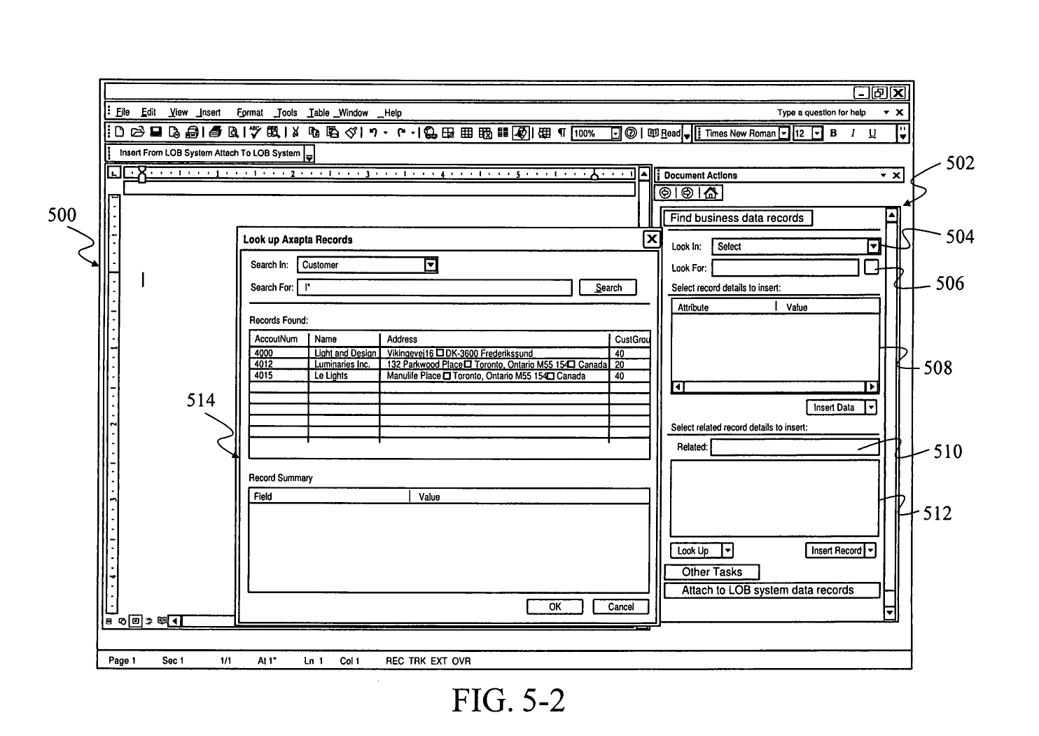

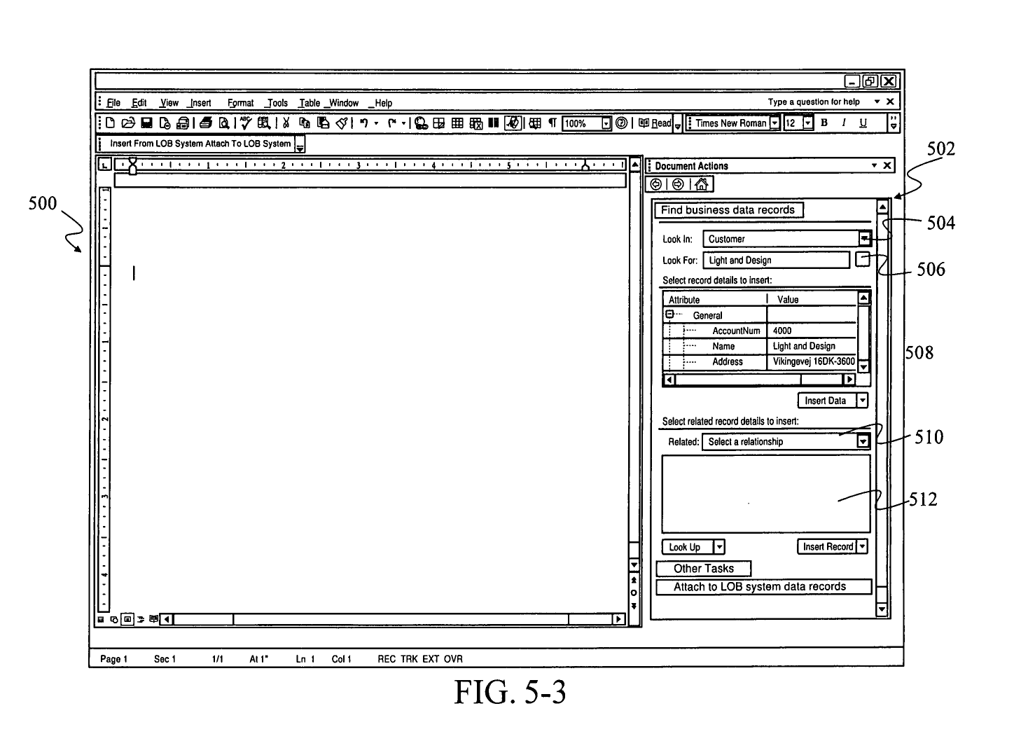

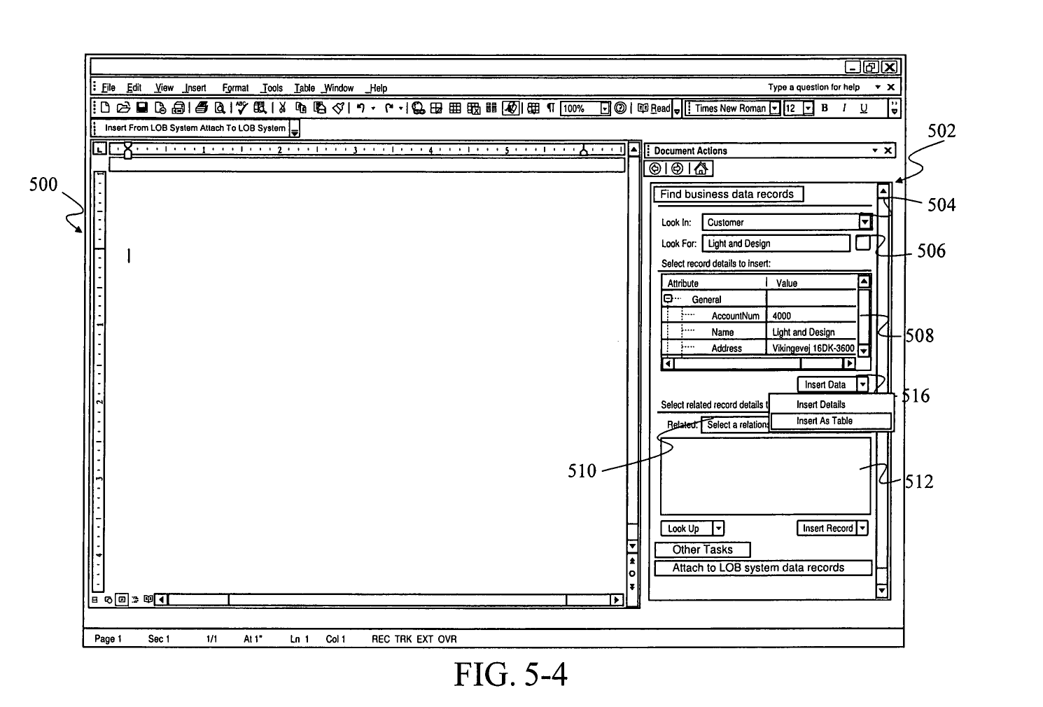

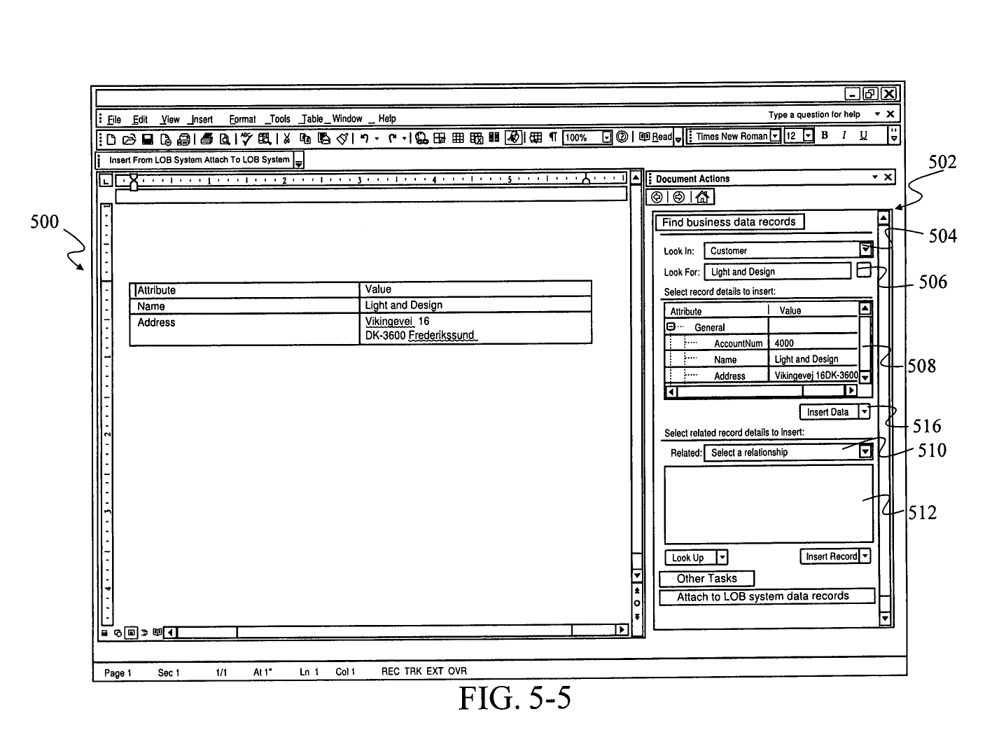

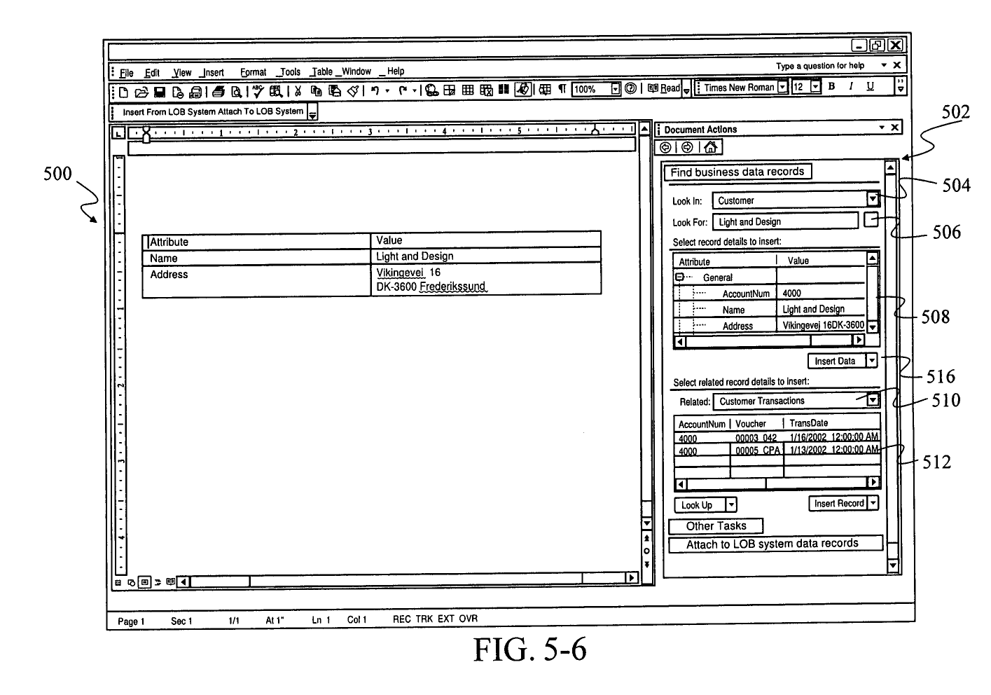

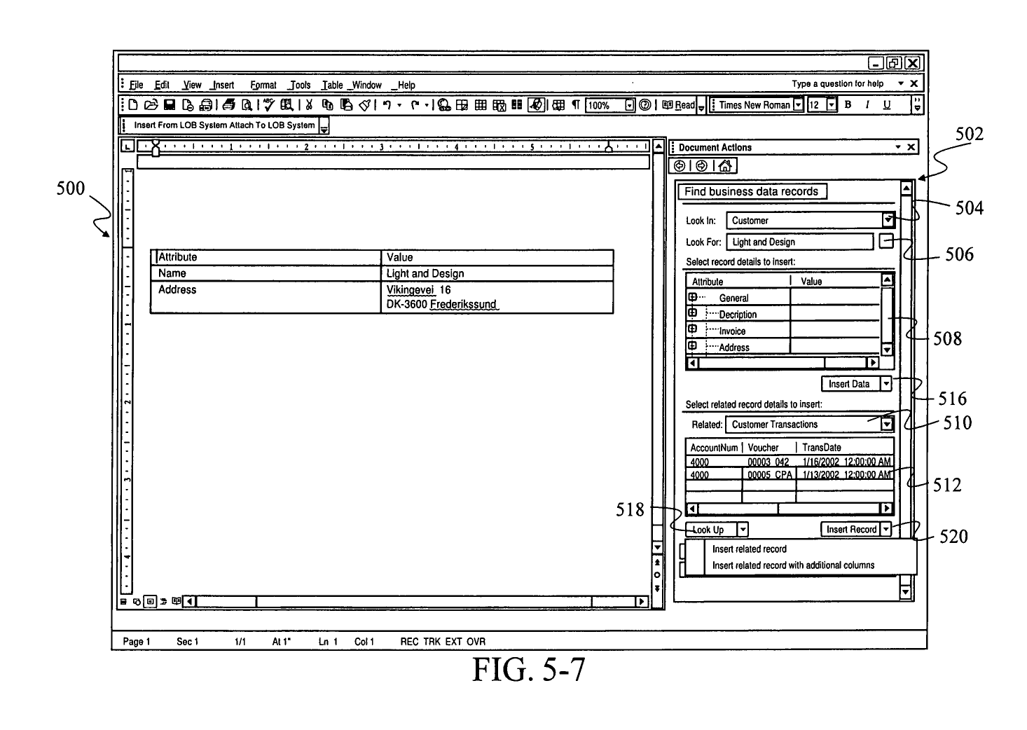

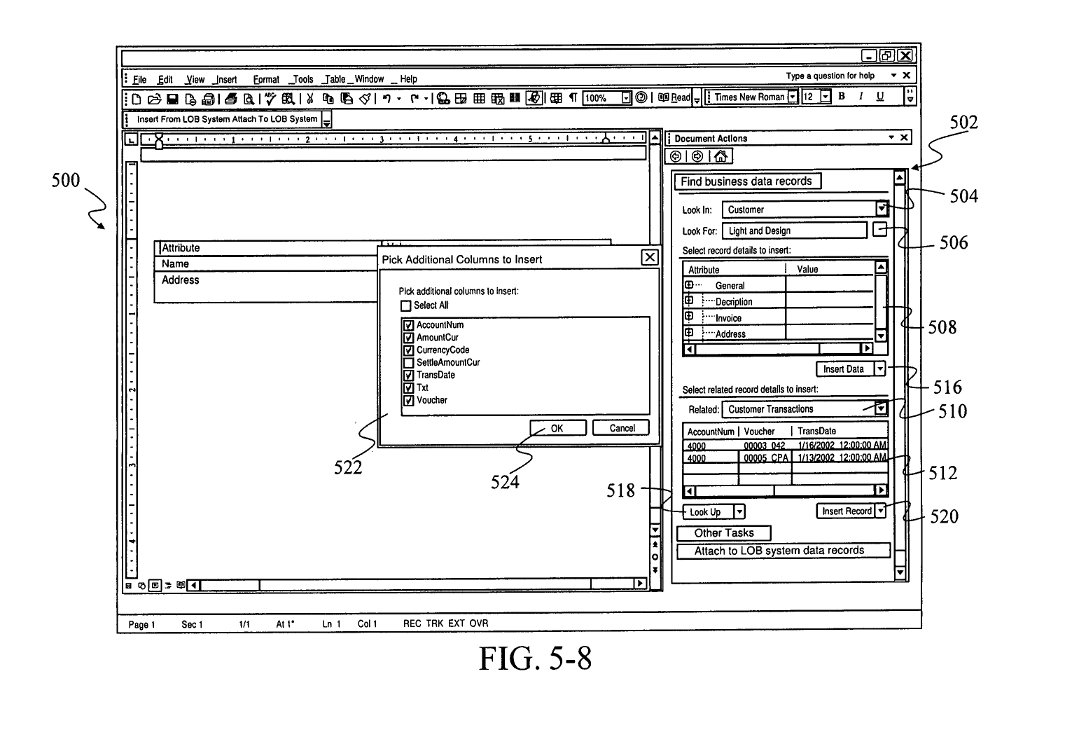

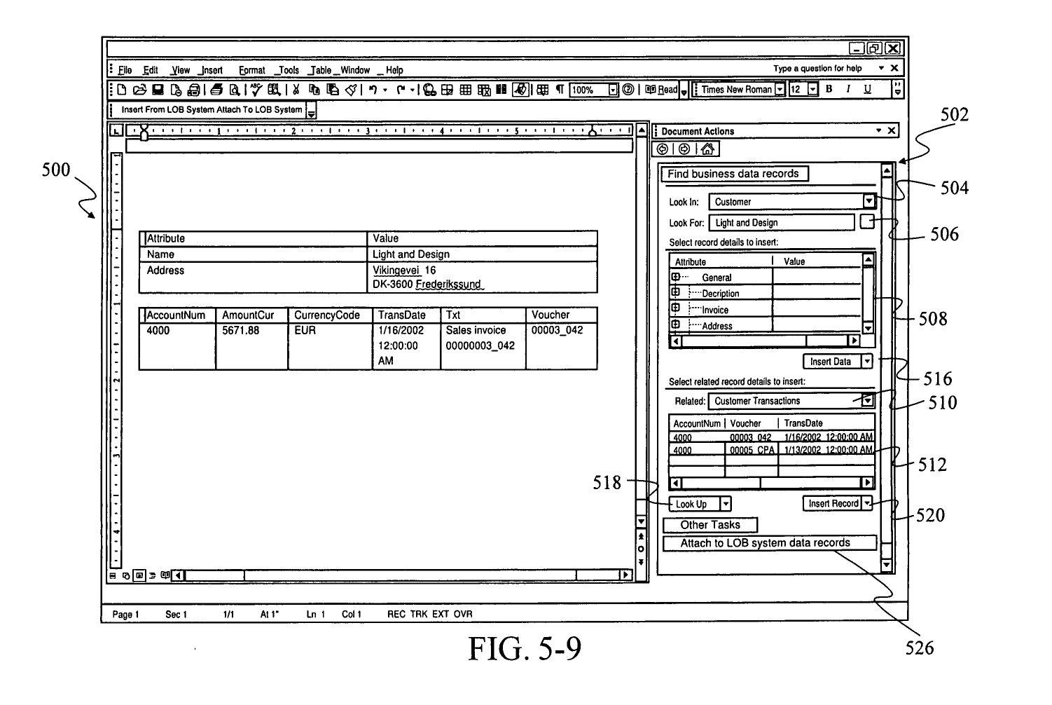

TABLE 1
(Notes on Tags)

| | Tag | Description |
|---|---|---|
| 1. | MaxRecordCount | Defines how many records |
| | | need to be shown per page, |
| | | in a details grid |
| | | (described further below) |
| | | in the embedded business |
| | | system user interface. |
| 2. | MetaDataRefreshTime | Time period after which the |
| | | cache should be refreshed. |
| 3. | CacheEntryCount | This count defines how many |
| | | records per entity should |
| | | be cached. |
| 4. | Entity Name | Schema name of an entity |
| | | which should be excluded |
| | | from the business system |
| | | user interface. |
| 5. | Related Name | Schema name of a related |
| | | entity which should be |
| | | excluded. Defining a |
| | | related entity here will |
| | | remove it from a related |
| | | records dropdown box |
| | | (described further below in |
| | | connection with FIGS. 5-1 |
| | | through 5-9), of the |
| | | embedded business system |
| | | user interface, for a |
| | | parent entity type. |
| 6. | Attribute Name | Schema name of attribute |
| | | which should be excluded |
| | | from details section of the |
| | | embedded business system |
| | | user interface for a given |
| | | entity. |

The above example configuration file includes a list of entities that will not be accessed. However, in some of the present embodiments, a different type of configuration file, that provides a list of entities that can be retrieved, may be used.

It should be noted that, in some of the present embodiments, managed code add-in 402 is developed using a guided interface tool 414, which provides a series of dialog boxes that guide a developer step by step through a procedure for developing components such as 402. Computer programming languages in which managed code add-in 402 can be developed include C# and Visual Basic. Of course, any other suitable programming languages that are currently available or will be developed in the future may be used.

In the embodiment of FIG. 4-1, a separate or non-shareable managed code add-in 402 can be used for a single IWP application (such as 302). However, as can be seen in block diagram 450 of FIG. 4-2, a single managed code add-in 452 can be shared across multiple IWP applications (302-1 and 302-2, for example). In such embodiments, the multiple IWP applications can be a part of a software suite (a collection of software products, usually applications of related functionality, often sharing a more-or-less common user interface and some ability to exchange data with each other smoothly). In the embodiment of FIG. 4-2, single or multiple configuration files (such as 408) may be used. Specific embedded business system interface embodiments are described below in connection with FIGS. 5-1 through 5-9.

### Specific Business System Interface Embodiments

FIGS. 5-1 through 5-9 are screen shots of an example IWP application user interface (or window) 500 with an embedded business system user interface (or pane) 502. As will be explained in detail below, in accordance with the present embodiments, embedded business system user interface 502 provides a drill-down functionality for browsing hierarchically organized business data.

As can be seen in FIG. 5-1, embedded business system user interface 502 includes, as its primary components, an entity selection dropdown box 504, an entity record filter 506, an entity record detail section 508, related record dropdown box 510 and a related record display section 512. Functions carried out by these components are described in connection with FIGS. 5-2 through 5-9 with the help of examples.

As can be seen in FIG. 5-2, a user has selected a particular entity (customer entity, for example) using entity selection dropdown box 504. Entity record filter 506 contains an ‘1’ followed by an asterisk, which indicates that all customer entity records with names starting with ‘1’ are desired. Therefore, a popup window 514 containing all customer entity records with names starting with ‘1’ is displayed.

As can be seen in FIG. 5-3, instead of selecting all customer entity records with names starting with ‘1,’ for example, the user can select a particular account name ((Light and Design, for example), and record details corresponding to the particular account name are displayed in entity record detail section 508. In entity record detail section 508, the user can also select certain data fields of the displayed record for insertion into IWP application interface section 500. The selected data fields are highlighted in FIG. 5-3.

FIG. 5-4 shows an insert data dropdown button 516 that provides the user with multiple format options for inserting the selected data fields. For example, if the user selects an “Insert As Table” format, a table containing the selected data is added to portion 500 as shown in FIG. 5-5.

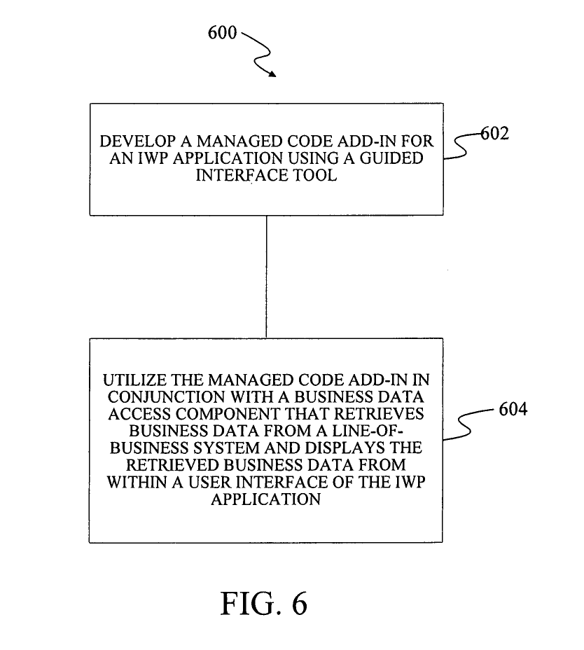

As can be seen in FIG. 5-6, using dropdown box 510, the user can have related records (customer transactions for account number 4000, for example) displayed in related record display section 512. The user can also select one or more records displayed in section 512. A first of the displayed records in section 512 is selected and therefore is highlighted as shown in FIG. 5-6.

FIG. 5-7 shows that insert record dropdown button 518 and look up dropdown button 520 provide a user with multiple options for handling data displayed in section 512. For example, a user can select “Insert related record with additional columns.” This results in the display of a popup window 522 that includes all column names for the customer transaction table, for example, as shown in FIG. 5-8. The user can select a subset (less than all) of the displayed column names and click on OK button 524.

As can be seen in FIG. 5-9, a table with the selected columns is inserted in portion 500. The business data insertion features allow the user to relatively easily include relevant business data into a word processing IWP application document, for example, without having to switch applications.

In general, if the IWP application is a word processing application, the embedded business system user interface includes a data insertion function for embedding business data in a document of the word processing application. Similarly, if the IWP application is a spreadsheet application, the embedded business system user interface includes a data insertion function for embedding business data in a workbook of the spreadsheet application. Also, the IWP application can be a messaging and scheduling application in which the embedded business system user interface is contained within a user interface of the messaging and scheduling application.

It should be noted that, in word processing and spreadsheet applications, the IWP user interface and the embedded business system user interface can, in some embodiments, be implemented at a document level (i.e., the developed IWP user interface with the embedded business system user interface can be deployed in the form of a document). In other embodiments, the IWP user interface and the embedded business system user interface are implemented at an application-level.

In addition to the above-described functions, some embodiments of the embedded business system user interface also allow a user to carry out other tasks such as attaching an IWP application file (document, workbook, etc.) to LOB system data records as shown in section 526 of FIG. 5-9. In such embodiments, the IWP application (such as 302 (FIG. 3)) cannot update any business data records in the LOB system (such as 304), but can insert an IWP application file into the LOB database (such as 412 (FIG. 4-1)). Here, in essence, information is transferred form IWP application 302 to LOB system 304 via business system interface 306. LOB systems (such as 304), in general, support attaching of different types of files to business data records. Of course, if attaching of files to records is not supported by a particular LOB system, it will have to be modified by adding database tables, etc., to provide the necessary support.

It should be noted that the earlier-described drill-down functionality, provided from within the IWP application, is configurable in some embodiments. In such embodiments, the drill-down functionality can be customized based on different customer or user requirements. It should also be noted that, in some embodiments, the functionality provided by component 402 (FIG. 4-1) can be achieved without utilizing managed code. In general, the present embodiments provide a generic LOB system data access application for viewing multiple entities and relationships in a functionally useful form.

FIG. 6 illustrates a flowchart 600 of an example method embodiment for providing access to business data in a LOB system from within an IWP application. At step 602, a managed code add-in is developed for the IWP application using a guided interface tool. At step 604, the managed code add-in is utilized in conjunction with a business data access component that can retrieve the business data from the LOB system and display the retrieved business data from within a user interface of the IWP application. In general, different techniques, some of which are set forth above, can be employed to carry out the steps shown in the flowchart of FIG. 6 while maintaining substantially the same functionality without departing from the scope and spirit of the present embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A business system interface for accessing data from a Line-of-Business (LOB) system from within an Information Worker Productivity (IWP) application, the business system interface comprising:
an embedded business system user interface contained within a user interface of the IWP application; and
a business data access component configured to retrieve data from the LOB system and to provide the retrieved data to the embedded business system user interface,
wherein the embedded business system user interface and the business data access component contain at least some managed code components.

2. The business system interface of claim 1 wherein the embedded business system user interface is configured to provide a configurable drill-down functionality for browsing hierarchically organized business data.

3. The business system interface of claim 1 wherein the at least some managed code components are generated with the help of a guided interface tool.

4. The business system interface of claim 1 wherein the IWP application is a word processing application and wherein the embedded business system user interface is contained within a user interface of the word processing application.

5. The business system interface of claim 4 wherein the embedded business system user interface comprises a data insertion function for embedding business data in a document of the word processing application.

6. The business system interface of claim 5 wherein the embedded business system user interface comprises an attachment function for attaching the document to at least one business data record.

7. The business system interface of claim 1 wherein the IWP application is a spreadsheet application and wherein the embedded business system user interface is contained within a user interface of the spreadsheet application.

8. The business system interface of claim 7 wherein the embedded business system user interface comprises a data insertion function for embedding business data in a workbook of the spreadsheet application.

9. The business system interface of claim 8 wherein the embedded business system user interface comprises an attachment function for attaching the workbook to at least one business data record.

10. The business system interface of claim 1 wherein the IWP application is a messaging and scheduling application and wherein the embedded business system user interface is contained within a user interface of the messaging and scheduling application.

11. A business system interface architecture comprising:
a managed code add-in that is at least partially embedded in a user interface of an IWP application; and
an entity handling component that assists in the retrieval of business data from a LOB system and provides the retrieved data to the managed code add-in.

12. The architecture of claim 11 and further comprising a business data cache.

13. The architecture of claim 11 and further comprising a configuration file that helps define an embedded business system user interface within a user interface of the IWP application.

14. The architecture of claim 11 wherein the managed code add-in is a shared managed code add-in, and wherein the IWP application is one of multiple IWP applications that utilizes the shared managed code add-in.

15. The architecture of claim 11 wherein the managed code add-in is non-shareable and wherein the IWP application is a single application that utilizes the non-shareable managed code add-in.

16. A method of providing access to business data in a LOB system from within an IWP application, the method comprising:
developing a managed code add-in for the IWP application using a guided interface tool, wherein the managed code add-in is configured to display the business data; and
utilizing the managed code add-in in conjunction with a business data access component configured to retrieve the business data from the LOB system and to display the retrieved business data from within a user interface of the IWP application.

17. The method of claim 16 wherein developing the managed code add-in for the IWP application comprises developing a non-shareable managed code add-in for the IWP application.

18. The method of claim 16 wherein developing the managed code add-in for the IWP application comprises developing a shared managed code add-in for use with multiple IWP applications that include the IWP application.

19. The method of claim 16 wherein the business data access component comprises an entity handling component and a business data cache.

20. The method of claim 19 wherein the business data cache is periodically refreshed with the help of the entity handling component.
